(19) United States
(12) Patent Application Publication
(10) Pub. No.: US 2021/0182457 A1
(43) Pub. Date: Jun. 17, 2021

(54) SIMULATION METHOD, SIMULATION APPARATUS, AND COMPUTER READABLE MEDIUM STORING PROGRAM

(71) Applicant: SUMITOMO HEAVY INDUSTRIES, LTD., Tokyo (JP)

(72) Inventor: Kiminori Sakai, Chiba (JP)

(21) Appl. No.: 17/125,305

(22) Filed: Dec. 17, 2020

(30) Foreign Application Priority Data
Dec. 17, 2019 (JP) 2019-227032

(51) Int. Cl. G06F 30/25; G06F 30/17

(52) U.S. Cl. CPC G06F 30/25; G06F 30/17

(57) ABSTRACT

Provided is a simulation method in which a member is represented by a collection of a plurality of particles and structural analysis is performed by applying a particle method, the simulation method including: determining a direction of a frictional force acting on a plurality of particles located on a surface at which two members to be analyzed are in contact with each other, based on an integrated displacement vector obtained by integrating a relative displacement vector for each time step between a reference point defined by a plurality of particles of one member and a reference point defined by a plurality of particles of the other member; and solving an equation of motion for the plurality of particles, based on the determined frictional force.

### RELATED APPLICATIONS

The content of Japanese Patent Application No. 2019-227032, on the basis of which priority benefits are claimed in an accompanying application data sheet, is in its entire incorporated herein by reference.

### BACKGROUND

### Technical Field

A certain embodiment of the present invention relates to a simulation method, a simulation apparatus, and a program.

### Description of Related Art

In the structural analysis of two members in contact, the magnitude of the Coulomb frictional force is expressed by the product of the normal force acting in the direction perpendicular to the contact surface and the coefficient of friction, and the direction of the Coulomb frictional force is determined according to the direction of relative velocity of the contact surface.

The related art below discloses a state analysis method for analyzing a slip state as to whether or not slip occurs in each part of the two members in the contact surface thereof.

### SUMMARY

According to an embodiment of the present invention,

there is provided a simulation method in which a member is represented by a collection of a plurality of particles and structural analysis is performed by applying a particle method, the simulation method including:

determining a direction of a frictional force acting on a plurality of particles located on a surface at which the two members to be analyzed are in contact with each other, based on an integrated displacement vector obtained by integrating a relative displacement vector for each time step between a reference point defined by a plurality of particles of one member and a reference point defined by a plurality of particles of the other member; and solving an equation of motion for the plurality of particles, based on the determined frictional force.

According to another embodiment of the present invention, there is provided a simulation apparatus including:

an input device to which simulation conditions are input;

a processing device that represents a member by a collection of a plurality of particles and performs structural analysis using a particle method, based on the simulation conditions input to the input device; and

an output device,

the processing device

determines a direction of a frictional force acting on a plurality of particles located on a surface at which the two members to be analyzed are in contact with each other, based on the integrated displacement vector obtained by integrating a relative displacement vector for each time step between a reference point defined by a plurality of particles of one member and a reference point defined by a plurality of particles of the other member,

solves the equation of motion for the plurality of particles, based on the determined frictional force, and

outputs an analysis result to the output device.

According to further embodiment of the present invention, there is provided a computer readable medium storing a process, the process including:

determining, in an analysis model in which two members to be analyzed are represented by a collection of a plurality of particles, the direction of a frictional force acting on a plurality of particles located on a surface at which the two members to be analyzed are in contact with each other, based on the integrated displacement vector obtained by integrating a relative displacement vector for each time step between a reference point defined by a plurality of particles of one member and a reference point defined by a plurality of particles of the other member; and

solving the equation of motion for the plurality of particles, based on the determined frictional force.

### BRIEF DESCRIPTION OF THE DRAWINGS

FIG. 1A is a schematic diagram showing an example of two members to be analyzed, and FIG. 1B is a diagram showing a part of an analysis model in which a first member and a second member are each represented by a collection of a plurality of particles.

FIG. 2 is a block diagram of a simulation apparatus according to an embodiment.

FIG. 3 is a flowchart of a simulation method according to the embodiment.

FIG. 4A, is a schematic diagram showing a triangular element defined by a plurality of particles located on a contact surface, and FIG. 4B is a schematic diagram showing a plurality of triangular elements of the first member.

FIG. 5A is a diagram schematically showing a change in a relative position of particles of the second member with respect to particles of the first member (FIG. 1B), and FIG. 5B is a schematic diagram for explaining physical meaning of the frictional force acting on the particles located on a contact surface in a static friction state.

FIG. 6 is a schematic diagram showing a simulation model.

FIG. 7A is a graph showing a temporal change in the magnitude of the frictional force when the direction of the frictional force generated on the contact surface between the first member and the second member is parallel to the integrated displacement vector, and FIG. 7B is a graph showing a temporal change in the magnitude of the frictional force when the direction of the frictional force is parallel to the direction of the relative velocity vector.

FIG. 8A is a graph showing a locus of movement of a sliding member in a simulation performed to check the effect of limiting the magnitude of the integrated displacement vector to a determination upper limit value, and FIG. 8B is a graph showing a temporal change in rotation angles θᵥ and θ_{F}.

### DETAILED DESCRIPTION

Since the particle method using the dynamic explicit method and the renormalization molecular dynamics method do not unbalance the forces, the particles (nodes) located on the contact surface slide while repeating vibration. The two surfaces in contact normally move in the sliding direction, but fluctuations of the velocity occur in the individual particles. When the frictional force is determined based on the relative velocity with fluctuations, for eachparticle located on the contact surface, the frictional forces at respective time steps are directed in various directions, and the Coulomb frictional force cannot be expressed appropriately. For example, the Coulomb frictional force originally acts in the macroscopic sliding direction, but the frictional force obtained in consideration of the fluctuation of the velocity also has a component in the direction orthogonal to the sliding direction. As a result, the frictional force acting in the sliding direction becomes smaller than the originally generated frictional force.

It is desirable to provide a simulation method, a simulation apparatus, and a program capable of introducing an appropriate Coulomb frictional force and performing structural analysis of two members by a dynamic explicit method.

The simulation method, simulation apparatus, and program according to the embodiment of the present invention will be described with reference to the drawings.

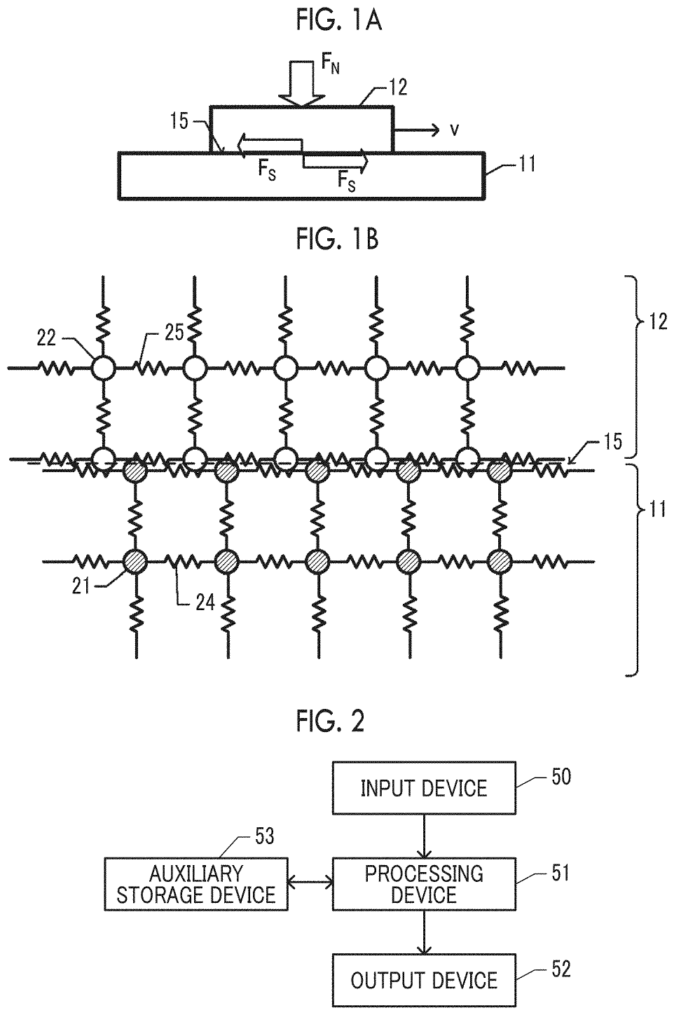

FIG. 1A is a schematic diagram showing an example of two members to be analyzed. A first member 11 and a second member 12 are in contact with each other on a contact surface 15. A normal force F_{N} is applied in a direction perpendicular to the contact surface 15. The second member 12 is moved with respect to the first member 11 in a direction parallel to the contact surface 15 at a velocity v. In this case, frictional forces Fₛ are generated on the contact surface 15. The frictional force Fₛ acting on the first member 11 has the same direction as the velocity v, the frictional force Fₛ acting on the second member 12 has a direction opposite to the velocity v.

FIG. 1B is a diagram showing a part of an analysis model in which the first member 11 and the second member 12 are represented by a collection of a plurality of particles 21 and 22, respectively. The plurality of particles 21 of the first member 11 are connected to each other by a spring 24, and the plurality of particles 22 of the second member 12 are connected to each other by a spring 25. The frictional force F acts on the particles 21 and 22 located on the contact surface 15. Values obtained by respectively summing the frictional forces F acting on the particles 21 and 22 located on the contact surface 15 are equal to the frictional forces Fₛ respectively acting on the first member 11 and the second member 12.

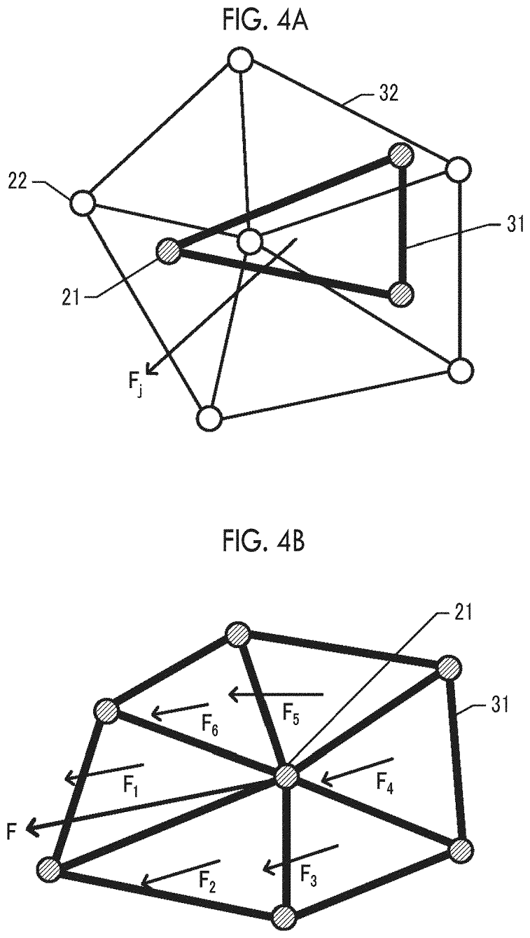

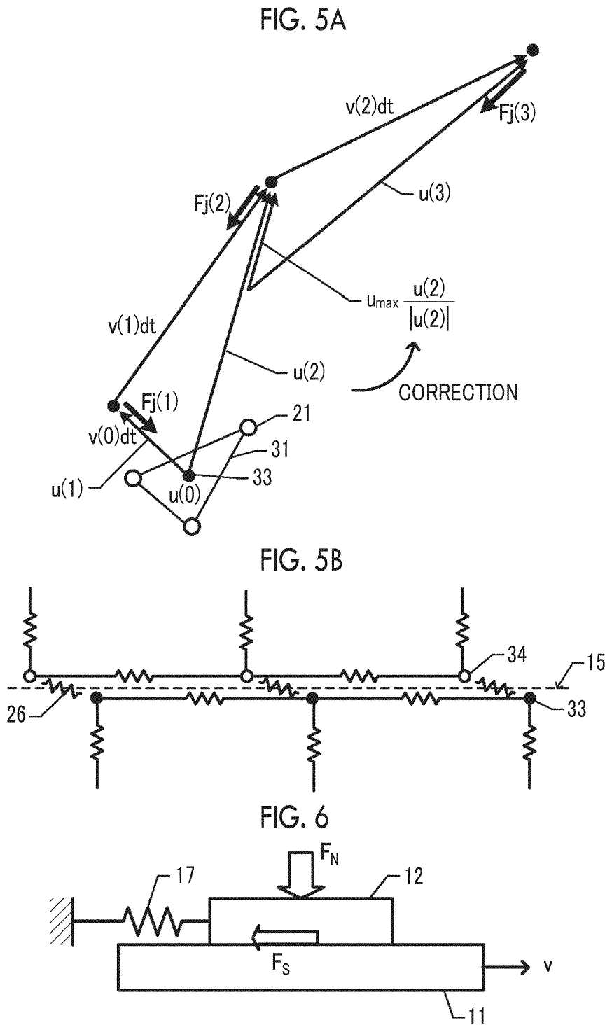

By fixing the positions of the plurality of particles 21 located on the bottom surface of the first member 11 and applying the normal force F_{N} to the plurality of particles 22 located on the uppermost surface of the second member 12 in a dispersed manner, the normal force F_{N} applied to the second member 12 is reproduced. By forcibly moving the plurality of particles 22 located on one side surface of the second member 12 at a velocity v, the relative velocity v of the second member 12 with respect to the first member 11 is reproduced. The frictional force F will be described later with reference to FIGS. 4A to 5B.

FIG. 2 is a block diagram of a simulation apparatus according to an embodiment. The simulation apparatus according to the embodiment includes an input device 50, a processing device 51, an output device 52, and an external storage device 53. Simulation conditions or the like are input from the input device 50 to the processing device 51. Further, various commands or the like are input from the operator to the input device 50. The input device 50 includes, for example, a communication device, a removable media reading device, a keyboard, or the like.

The processing device 51 performs a simulation using the molecular dynamics method or the renormalization molecular dynamics method, based on the input simulation conditions and commands. The processing device 51 is a computer including a central processing unit (CPU), a main storage device (main memory), and the like. The simulation program executed by the computer is stored in the external storage device 53. For the external storage device 53, for example, a hard disk drive (HDD), a solid state drive (SSD), or the like is used. The processing device 51 reads the program stored in the external storage device 53 into the main storage device and executes the program.

The processing device 51 outputs the simulation result to the output device 52. The simulation result includes information indicating the state of a plurality of particles representing the member to be analyzed, the temporal change of the physical quantity of the particle system composed of the plurality of particles, or the like. The output device 52 includes, for example, a communication device, a removable media writing device, a display, and the like.

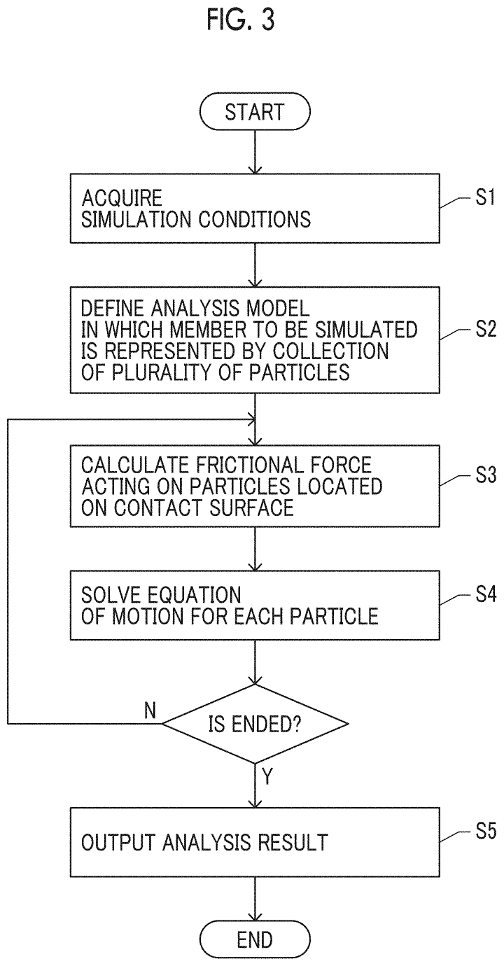

FIG. 3 is a flowchart of a simulation method according to the embodiment.

First, the processing device 51 acquires the simulation conditions input to the input device 50 (step S1). The simulation conditions include information that defines the geometric shapes and relative positional relationships of the first member 11 and the second member 12, physical property information of the first member 11 and the second member 12, friction coefficient, external force applied to the first member 11 and the second member 12, velocity, or the like.

When the processing device 51 acquires the simulation conditions, the processing device 51 defines an analysis model in which the first member 11 and the second member 12 to be simulated are represented by a collection of a plurality of particles (step S2). After that, the frictional force F acting on the plurality of particles 21 and 22 located on the contact surface 15 (FIGS. 1A and 1B) of the analysis model is calculated (step S3). The method of obtaining the frictional force F will be described later with reference to FIGS. 4A to 5B.

Next, the equation of motion is solved for each of the particles 21 and 22 (step S4). In this case, a frictional force F acts on the particles located on the contact surface 15. As a result, the states of the particles 21 and 22 at the time when one time step has elapsed is obtained. When continuing the analysis, the frictional force F is calculated again (step S3), the equation of motion is solved (step S4), and the time step is advanced. When the analysis is ended, the analysis result is output to the output device 52 (step S5).

Next, a method of calculating the frictional force F acting on the particles 21 and 22 located on the contact surface 15 (FIG. 1B) will be described with reference to FIGS. 4A to 5B.

First, with reference to FIG. 4A, a combination of the plurality of particles 21 of the first member 11 and the plurality of particles 22 of the second member 12 that exert frictional forces on each other will be described.

FIG. 4A is a schematic diagram showing a triangular element defined by a plurality of particles 21 and 22 located on the contact surface 15. The generation of triangular elements can be performed using various well-known algorithms. One triangular element 31 is defined by the three particles 21 of the first member 11. A plurality of triangular elements 32 (five triangular elements 32 in FIG. 4A) defined by a plurality of particles of the second member 12 partially overlap one triangular element 31 in a plan view. It is considered that a frictional force is generated between the triangular elements due to the relative displacement of the centers of gravity of the partially overlapping triangular element 31 and the triangular elements 32.

The triangular element 31 of the first member 11 receives a frictional force from each of the plurality of triangular elements 32 of the second member 12, that partially overlap the triangular element 31. By synthesizing this frictional force, the frictional force Fj acting on the triangular element 31 can be obtained.

FIG. 4B is a schematic diagram showing a plurality of triangular elements 31 of the first member 11. The plurality of triangular elements 31 (six triangular elements 31 in FIG. 4B) with one particle 21 of the first member 11 as one vertex are defined. With respect to each of the six triangular elements 31 including the particle 21A of interest, the frictional force Fj (j=1, 2, 3, 4, 5, 6) acting on the triangular element 31 is weighted by masses of three particles 21 located at the vertices of the triangular element and distributed to the particles 21. When the masses of the three particles 21 are equal, the frictional force distributed to each of the particles 21 is ⅓ of the frictional force Fj acting on the triangular element 31. The frictional force F acting on the particle 21A of interest is obtained by synthesizing the frictional force distributed to the particle 21A.

Next, a method of obtaining the frictional force acting on the triangular element will be described with reference to FIGS. 5A and 5B.

FIG. 5A is a diagram schematically showing a change in the relative position of the center of gravity 33 of one triangular element 31 of the first member 11 with respect to the center of gravity of one triangular element 32 (FIG. 4A) of the second member 12. When the velocity vectors of the particles 21 located at the three vertices of the triangular element 31 are expressed as v1, v2, and v3, respectively, and the respective masses are expressed as m1, m2, and m3, the velocity vector vc of the center of gravity 33 is expressed by the following equation.

$$\begin{matrix}[ Equation 1 ] & \\ v o = \frac{m 1 \cdot v 1 + m 2 \cdot v 2 + m 3 \cdot v 3}{m 1 + m 2 + m 3} & ( 1 )\end{matrix}$$

The relative velocity vector of the center of gravity 33 of one triangular element 31 of the first member 11 with respect to the center of gravity of one triangular element 32 (FIG. 4A) of the second member 12 can be obtained from the velocity vector vc of the center of gravity 33 of the triangular element 31 of the first member 11 and the velocity vector of the center of gravity of the triangular element 32 of the second member 12.

The integrated displacement vector obtained by integrating the relative displacement vector for each time step in the direction parallel to the contact surface 15 from the initial state of the center of gravity 33 is expressed as u, and the relative velocity vector in the direction parallel to the contact surface 15 is expressed as v. The integrated displacement vector and relative velocity vector in the initial state are expressed as u(0) and v(0), respectively, and the integrated displacement vector and relative velocity vector after the execution of the i-th time step are expressed as u(i) and v(i), respectively. The time width of the time step is expressed as dt. The relative displacement vector in the i-th time step can be expressed as v(i−1)dt.

The integrated displacement vector u(i) after the execution of the i-th time step is expressed by the following equation.

[Equation 2]

u(i)=u(i−1)+v(i−1)dt (2)

When the magnitude of the integrated displacement vector u(i) exceeds a predetermined determination upper limit value uₘₐₓ, the integrated displacement vector u(i) is corrected such that the magnitude of the integrated displacement vector u(i) becomes equal to the determination upper limit value uₘₐₓ. That is, the following correction is performed.

$$\begin{matrix}[ Equation 3 ] & \\ u ( i ) = {u}_{max} \frac{u ( i )}{\vert u ( i ) \vert} & ( 3 )\end{matrix}$$

The integrated displacement vector u (i+1) is calculated based on the corrected integrated displacement vector u(i). In the example shown in FIG. 5A, since the magnitude of the integrated displacement vector u(2) exceeds the determination upper limit value uₘₐₓ, the magnitude of the integrated displacement vector u(2) is corrected to uₘₐₓ. The integrated displacement vector u(3) is calculated based on the corrected integrated displacement vector u(2).

Next, the frictional force Fj acting on the center of gravity 33 in a dynamic friction state (sliding state) where the second member 12 is moving with respect to the first member 11 will be described. The frictional force Fj(i) in the dynamic friction state acting on the center of gravity 33 in the state after the execution of the i-th time step is calculated using the following equation.

$$\begin{matrix}[ Equation 4 ] & \\ j ( i ) = - μ \vert {N}_{} ( i ) \vert \frac{u ( i )}{\vert u ( i ) \vert} & ( 4 )\end{matrix}$$

Here, μ is a dynamic friction coefficient, and F_{N}(i) is the normal force acting on the triangular element 31. The direction of the frictional force Fj acting on the center of gravity of the triangular element 32 (FIG. 4A) of the second member 12 is opposite to the direction of the frictional force Fj acting on the center of gravity 33 of the triangular element 31 of the first member 11. Equation (4) means that the magnitude of the frictional force Fj(i) is equal to the product of the dynamic friction coefficient p and the magnitude of the normal force F_{N}. Further, the direction of the frictional force Fj(i) means that the direction is opposite to the direction of the integrated displacement vector u(i).

Next, the frictional force Fj in the static friction state (fixed state) in which the first member 11 is fixed to the second member 12 will be described. The frictional force Fj(i) in the static friction state acting on the center of gravity 33 of the triangular element 31 of the first member 11 in the state after the execution of the i-th time step is calculated by using the following equation.

[Equation 5]

[symbol]

j(i)=Ku(i) (5)

Here, K is a proportionality constant.

Next, the physical meaning of Equation (5) will be described.

FIG. 5Bis a schematic diagram for explaining the physical meaning of the frictional force Fj acting on the centers of gravity 33 and 34 of the triangular elements 31 and 32 in the static friction state. In the static friction state, it is considered that the center of gravity 33 and the center of gravity 34 are connected by the spring 26. The proportionality constant K in Equation (5) corresponds to the spring constant of the spring 26. That is, when the center of gravity 33 is displaced with respect to the center of gravity 34 in the direction parallel to the contact surface 15, a restoring force that tries to return the center of gravity 33 to the original position acts by the spring 26.

Next, an example of the magnitude of the determination upper limit value uₘₐₓ included in Equation (3) will be described.

In a static friction state where the first member 11 and the second member 12 are fixed to each other, when a force in the sliding direction is applied to the second member 12 with respect to the first member 11, a shearing force is generated on the contact surface 15 between the two members. When the shearing force is equal to or less than the maximum static frictional force, the fixed state is maintained. When the shearing force exceeds the maximum static frictional force, the second member 12 begins to slide with respect to the first member 11.

When the determination upper limit value uₘₐₓ is defined as the magnitude of the relative displacement vector in a state where the shearing force and the maximum static frictional force are balanced, the determination upper limit value uₘₐₓ is expressed by the following equation.

[Equation 6]

Kuₘₐₓ =μ| [symbol] _{N}(i)| (6)

Here, K represents the proportionality constant K of Equation (5), and F_{N}(i) is a normal force acting in a direction perpendicular to the contact surface 15 after the i-th time step. As an example, the determination upper limit value uₘₐₓ may be set so as to satisfy Equation (6).

Next, the excellent effects of the above embodiment will be described.

The direction of the frictional force generated on the contact surface of the two members is parallel and antiparallel to the direction of the relative velocity of the two members. When structural analysis is performed using the particle method, if a frictional force acts on each particle based on the relative velocity of the particles located on the contact surface, the direction of the frictional force is affected by the fluctuation of the relative velocity. When affected by this fluctuation, the direction of the frictional force acting on each particle deviates from the direction of the actual frictional force generated on the contact surface of the two members.

In the above embodiment, as shown in FIG. 5A and Equations (4) and (5), the direction of the frictional force Fj i) is determined based on the integrated displacement vector u(i) rather than the relative velocity vector v(i). A plurality of past relative velocity vectors v(i) are accumulated in the integrated displacement vector u(i). That is, the fluctuation of the relative velocity vector v(i) is also accumulated. Since the fluctuations of the relative velocity vector v(i) are random, when the fluctuations are accumulated, the plurality of fluctuations cancel each other out to reduce the influence of the fluctuations. Therefore, the integrated displacement vector u(i) is unlikely to be affected by the temporary fluctuation of the relative velocity vector v(i). As shown in FIG. 4B, the frictional force F acting on the particles 21 is obtained by synthesizing the frictional force Fj(i) acting on the center of gravity 33 of the triangular element 31 of the first member 11, so that the frictional force F acting on the particles 21 is unlikely to be affected by the fluctuation of the velocity vector of the particles 21. The same applies to the frictional force F acting on the particles 22 of the second member 12. Therefore, a difference between the direction of the frictional force F(i) acting on the particles 21 and 22 and the direction of the frictional force generated on the contact surface 15 between the first member 11 and the second member 12 can be reduced. As a result, the accuracy of structural analysis can be improved.

When the time step of the calculation advances and the magnitude of the integrated displacement vector u(i) becomes significantly larger compared to the magnitude of the relative displacement vector v(i−1)dt for one time step, the direction of the current relative velocity is less likely to be reflected in the direction of the frictional force Fj. In the above embodiment, as shown in Equation (3), when the magnitude of the integrated displacement vector u(i) exceeds the determination upper limit value uₘₐₓ, the integrated displacement vector u(i) is corrected such that the magnitude thereof is equal to the determination upper limit value uₘₐₓ. Therefore, it is possible to avoid the inconvenience that the direction of the current relative velocity is less likely to be reflected in the direction of the frictional force F.

When the determination upper limit value uₘₐₓ is made significantly large, the effect due to limiting the magnitude of the integrated displacement vector u(i) to the determination upper limit value uₘₐₓ is reduced. The determination upper limit value uₘₐₓ is preferably equal to or less than the magnitude of the relative displacement vector when the shearing force acting on the particles 21 and 22 located on the contact surface 15 of the two members and the maximum static frictional force are balanced.

On the contrary, when the determination upper limit value uₘₐₓ is made significantly small, the direction of the frictional force Fj is likely to be affected by the fluctuation of the relative velocity vector v. The determination upper limit value uₘₐₓ is preferably sufficiently larger than the magnitude of the fluctuation of the relative displacement vector v(i) dt in one time step.

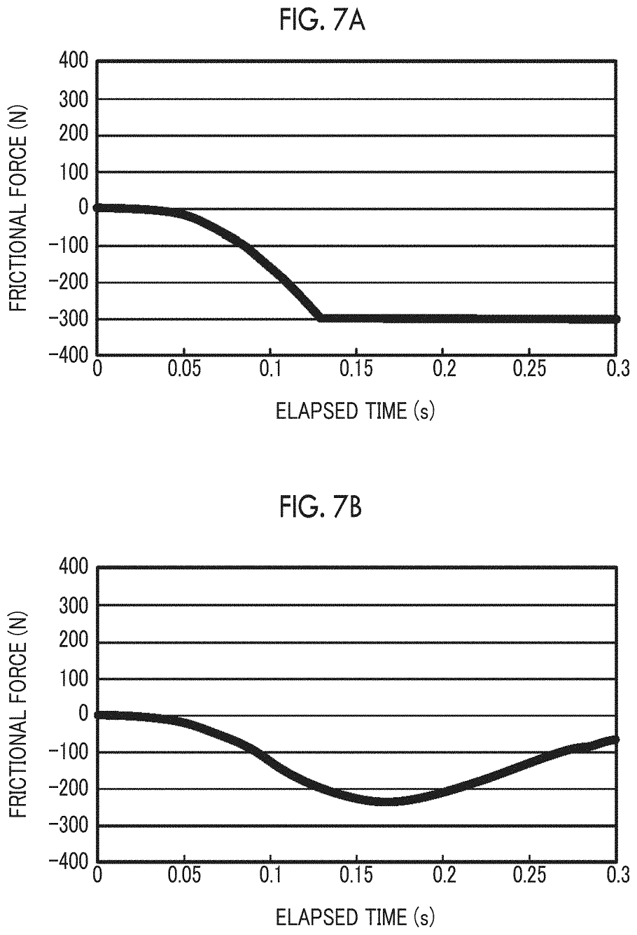

Next, with reference to FIGS. 6 to 7B, an actual simulation performed to check the effect of the above embodiment and the result thereof will be described.

FIG. 6 is a schematic diagram showing a simulation model. A plate-shaped second member 12 is placed on the plate-shaped first member 11, and the upper surface of the first member 11 and the lower surface of the second member 12 are in contact with each other. A normal force F_{N} is applied to the upper surface of the second member 12. The position of the lower surface of the first member 11 in the height direction is fixed. The frictional forces Fₛ are generated on the contact surface between the first member 11 and the second member 12.

One side surface of the first member 11 is forcibly moved at a velocity v. A spring 17 is attached to the side surface of the second member 12 facing in the direction opposite to the velocity v, and when the spring 17 is extended, a restoring force in the direction opposite to the velocity v acts on the side surface of the second member 12.

FIG. 7A is a graph showing a temporal change in the magnitude of the frictional force when the direction of the frictional force generated on the contact surface between the first member 11 and the second member 12 is parallel to the integrated displacement vector u (FIG. 5A). The horizontal axis represents the elapsed time in the unit “s”, and the vertical axis represents the magnitude of the frictional force in the unit “N”. It is assumed that the magnitude of the normal force F_{N} is 1000 N, and the static friction coefficient and the dynamic friction coefficient are both 0.3. As the physical property values of the first member 11 and the second member 12, the physical property value of iron is used.

Immediately after the start of movement of the first member 11, the second member 12 moves following the first member 11. As the amount of movement of the second member 12 increases, the spring 17 is extended and the restoring force of the spring 17 increases. When the restoring force of the spring 17 exceeds the maximum static frictional force, the second member 12 starts to slide with respect to the first member 11. The frictional force at this time is 300N obtained by multiplying the magnitude 1000N of the normal force _{FN} by the static friction coefficient 0.3.

In the graph shown in FIG. 7A, the period in which the magnitude of the frictional force increases in the negative direction with the passage of time corresponds to the state in which the second member 12 is fixed to the first member 11. At the time when about 0.13 seconds have passed from the start of forced movement of the first member 11, the magnitude of the frictional force reaches 300N, which is the maximum static frictional force. This time corresponds to the time when the second member 12 starts to slide with respect to the first member 11. In the present simulation, since the dynamic friction coefficient and the static friction coefficient are set to be the same, the magnitude of the frictional force is constant at about 300 N after the second member 12 starts to slide. From this result, it can be seen that in the simulation method according to the embodiment, the frictional force acting on each particle can almost accurately reproduce the actual frictional force.

FIG. 7B is a graph showing a temporal change in the magnitude of the frictional force when the direction of the frictional force is parallel to the direction of the relative velocity vector v (FIG. 5A). In the example shown in FIG. 7B, the magnitude of the frictional force increases with the passage of time, but the magnitude of the frictional force begins to decrease without reaching the maximum static frictional force. This is because the frictional force calculated at each time step of the simulation does not reproduce the original frictional force.

From the simulation results shown in FIGS. 6 to 7B, it is checked that the Coulomb frictional force can be reproduced sufficiently and accurately, in the simulation method according to the above embodiment.

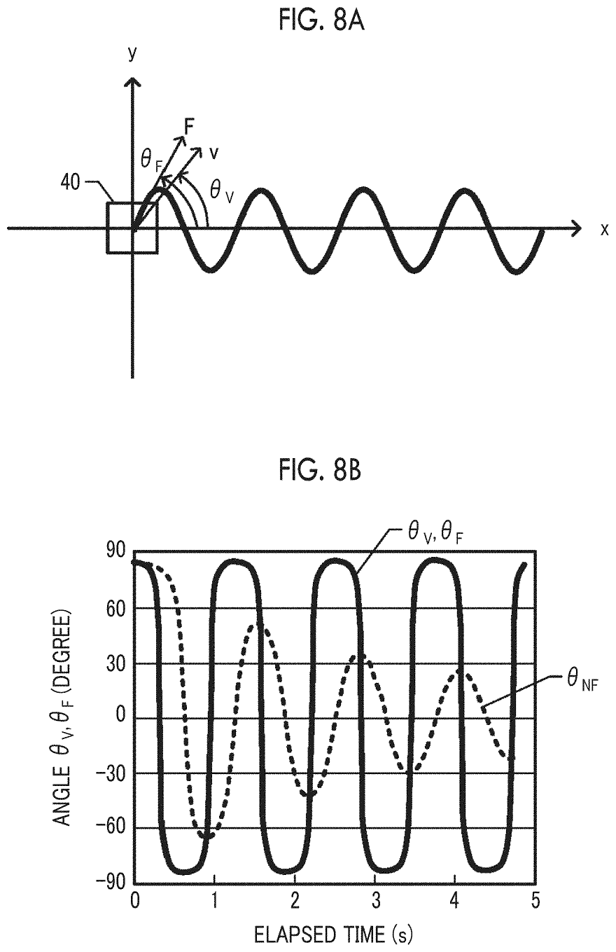

Next, as shown in Equation (2), a simulation performed to check the effect of limiting the magnitude of the integrated displacement vector u(i) to the determination upper limit value uₘₐₓ, and the result thereof will be described with reference to FIGS. 8A and 8B. In the present simulation, a sliding member is placed on the support surface, and the sliding member is forcibly moved with respect to the support surface.

FIG. 8A is a graph showing the locus of movement of the sliding member 40 performed in the present simulation. The sliding member 40 is moved at a constant velocity in the x-axis direction and is simply vibrated in the y-axis direction. Thus, the locus of the sliding member 40 becomes a sine wave shape. The rotation angle from the x-axis to the relative velocity vector v of the sliding member 40 is expressed as θᵥ. The rotation angle from the x-axis to the frictional force F acting on the support surface is expressed as θ_{F}.

FIG. 8B is a graph showing temporal changes of rotation angles θᵥ and θ_{F}. The solid line shown in FIG. 8B shows the rotation angles θᵥ and θ_{F}. The two rotation angles are almost identical. For comparison, a simulation is performed without limiting the magnitude of the integrated displacement vector u(i). The rotation angle from the x-axis to the frictional force F calculated in the simulation by the comparative example is expressed as θ_{NF}. In FIG. 8B, the rotation angle θ_{NF} is shown by a broken line. In the comparative example, it can be seen that the direction of the frictional force F deviates greatly from the direction of the relative velocity vector v.

By the simulations shown in FIGS. 8A and 8B, the effect of correcting the integrated displacement vector u(i) based on Equation (2) such that the magnitude of the integrated displacement vector u (i) does not exceed the determination upper limit value uₘₐₓ is checked.

In the above embodiment, when the integrated displacement vector u(i) exceeds the determination upper limit value uₘₐₓ, the magnitude of the integrated displacement vector u(i) is corrected to be equal to the determination upper limit value uₘₐₓ, but the obtained magnitude of the integrated displacement vector u(i) may be corrected so as to be smaller than the determination upper limit value uₘₐₓ.

In the above embodiment, a triangular element having a particle located on the contact surface of each of the two members as a vertex is defined and the frictional force is obtained for each pair of the triangular elements. However, a polygonal element other than the triangular element may be defined, and the frictional force is obtained for each pair of the polygonal elements. Further, in the above embodiment, the center of gravity of the triangular element is adopted as the reference point for obtaining the relative displacement vector for each pair of the triangular elements, but other points may be adopted as the reference point. For example, the geometric center position of the triangular element may be adopted as a reference point. In this way, the reference point may be defined based on the positions of the plurality of particles.

In the above embodiment, a simulation is performed on an analysis model in which the contact surface of the two members is flat, but the contact surface does not necessarily need to be flat. For example, the simulation method according to the above embodiment can be applied to structural analysis of a member having a columnar surface such as a contact surface of a sliding bearing or a contact surface between a piston and a cylinder. Further, it can be applied to the structural analysis of a member whose contact surface is spherical.

The above-described embodiment is an example, and the present invention is not limited to the above-described embodiment. For example, it will be apparent to those skilled in the art that various modifications, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A simulation method in which a member is represented by a collection of a plurality of particles and structural analysis is performed by applying a particle method, the simulation method comprising:
determining a direction of a frictional force acting on a plurality of particles located on a surface at which the two members to be analyzed are in contact with each other, based on an integrated displacement vector obtained by integrating a relative displacement vector for each time step between a reference point defined by a plurality of particles of one member and a reference point defined by a plurality of particles of the other member; and
solving an equation of motion for the plurality of particles, based on the determined frictional force.

2. The simulation method according to claim 1, wherein
the reference point is a center of gravity of each of a plurality of triangular elements defined by positions of the plurality of particles located on the surface at which the two members to be analyzed are in contact with each other.

3. The simulation method according to claim 2, wherein
the frictional force is determined for each pair of the triangular elements defined by the plurality of particles of one member to be analyzed and the triangular elements defined by the plurality of particles of the other member, and
the frictional force determined for each pair of the triangular elements is distributed to particles located at vertices of the triangular elements, and the frictional force acting on the particles is determined.

4. The simulation method according to claim 1, wherein
when a magnitude of the integrated displacement vector exceeds a determination upper limit value in a certain time step, the magnitude of the integrated displacement vector is corrected to be smaller than a magnitude of the obtained integrated displacement vector, and in a next time step, a relative displacement vector in the time step is added to the corrected integrated displacement vector.

5. The simulation method according to claim 4, wherein
when the magnitude of the integrated displacement vector exceeds the determination upper limit value in a certain time step, the magnitude of the integrated displacement vector is corrected to match the determination upper limit value.

6. The simulation method according to claim 5, wherein
when the two members to be analyzed are in a static friction state, the magnitude of the relative displacement vector when a shearing force acting on the particles located on the contact surface of the two members and a maximum static frictional force are balanced is used as the determination upper limit value.

7. A simulation apparatus comprising:
an input device to which simulation conditions are input;
a processing device that represents a member by a collection of a plurality of particles and performs structural analysis using a particle method, based on the simulation conditions input to the input device; and
an output device,
the processing device
determines a direction of a frictional force acting on a plurality of particles located on a surface at which the two members to be analyzed are in contact with each other, based on the integrated displacement vector obtained by integrating a relative displacement vector for each time step between a reference point defined by a plurality of particles of one member and a reference point defined by a plurality of particles of the other member,
solves the equation of motion for the plurality of particles, based on the determined frictional force, and
outputs an analysis result to the output device.

8. A computer readable medium storing a process, the process comprising:
determining, in an analysis model in which two members to be analyzed are represented by a collection of a plurality of particles, the direction of a frictional force acting on a plurality of particles located on a surface at which the two members to be analyzed are in contact with each other, based on the integrated displacement vector obtained by integrating a relative displacement vector for each time step between a reference point defined by a plurality of particles of one member and a reference point defined by a plurality of particles of the other member; and
solving the equation of motion for the plurality of particles, based on the determined frictional force.

9. The simulation method according to claim 2, wherein
when a magnitude of the integrated displacement vector exceeds a determination upper limit value in a certain time step, the magnitude of the integrated displacement vector is corrected to be smaller than a magnitude of the obtained integrated displacement vector, and in a next time step, a relative displacement vector in the time step is added to the corrected integrated displacement vector.

10. The simulation method according to claim 9, wherein
when the magnitude of the integrated displacement vector exceeds the determination upper limit value in a certain time step, the magnitude of the integrated displacement vector is corrected to match the determination upper limit value.

11. The simulation method according to claim 10, wherein
when the two members to be analyzed are in a static friction state, the magnitude of the relative displacement vector when a shearing force acting on the particles located on the contact surface of the two members and a maximum static frictional force are balanced is used as the determination upper limit value.

12. The simulation method according to claim 3, wherein
when a magnitude of the integrated displacement vector exceeds a determination upper limit value in a certain time step, the magnitude of the integrated displacement vector is corrected to be smaller than a magnitude of the obtained integrated displacement vector, and in a next time step, a relative displacement vector in the time step is added to the corrected integrated displacement vector.

13. The simulation method according to claim 12, wherein
when the magnitude of the integrated displacement vector exceeds the determination upper limit value in a certain time step, the magnitude of the integrated displacement vector is corrected to match the determination upper limit value.

14. The simulation method according to claim 13, wherein
when the two members to be analyzed are in a static friction state, the magnitude of the relative displacement vector when a shearing force acting on the particles located on the contact surface of the two members and a maximum static frictional force are balanced is used as the determination upper limit value.

15. A simulation method using the simulation apparatus according to claim 7 comprising:
determining the direction of the frictional force acting on the plurality of particles located on the surface at which the two members to be analyzed are in contact with each other, based on the integrated displacement vector obtained by integrating the relative displacement vector for each time step between the reference point defined by the plurality of particles of one member and a reference point defined by the plurality of particles of the other member; and
solving the equation of motion for the plurality of particles, based on the determined frictional force.

16. A computer readable medium storing the process according to claim 15.
